(19) United States
(12) Patent Application Publication
(10) Pub. No.: US 2006/0129892 A1
(43) Pub. Date: Jun. 15, 2006

(54) Scenario based stress testing

(75) Inventors: Claudiu G. Diaconu, Bellevue, WA (US); Eric J. Govreau, Puyallup, WA (US); Zhenrong Qian, Mountain View, CA (US)

Correspondence Address: AMIN & TUROCY, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/000,274

(22) Filed: Nov. 30, 2004

(51) Int. Cl. G06F 11/00

(52) U.S. Cl. 714/38

(57) ABSTRACT

The subject invention relates to systems and methods for automatically testing and stressing computer components on a plurality of computer systems. In one aspect, a system is provided to facilitate software testing of a computing environment. The system includes one or more profiles that describe software actions related to operations of a computing system, wherein the actions can be specified from usage data gathered or modeled from various sources. A weighting component specifies likelihoods of the software actions in order to more closely test or model actual operations of the computing system, whereby a test selection module employs the likelihoods to determine software tests that exercise the software actions in order to predict future behavior of the computing system.

### TECHNICAL FIELD

The subject invention relates generally to computer systems, and more particularly, the subject invention relates to a system that employs a profile and weighting component to simulate, stress, and exercise a plurality of variable computer system configurations in accordance with a determined or weighted likelihood of user actions or system load.

### BACKGROUND OF THE INVENTION

In modern computing systems, software quality assurance (SQA) is an important part of verifying software components before actual deployment of the components by end users. This generally includes a planned systematic pattern of the actions necessary to provide adequate confidence that a product, component, or process by which the product is developed, conforms to established requirements. Also, SQA methods are more broadly applied to any software development such as to an updated version of commercial software to correct errors, resolve incompatibilities, or improve software performance.

In accordance with SQA methodology, software reliability considerations include the probability that software will not cause a system failure for a specified time under specified conditions. This probability is generally a function of one or more inputs to and use of the system in accordance with the software. The inputs to the system determine whether existing faults, if any, are encountered. Moreover, reliability estimates include the ability of a program to perform its required functions accurately and reproducibly under stated conditions for a specified period of time. Furthermore, reliability includes the probability that a given software component operates for some time period on the machine or machines for which it was designed, without system failure due to a software fault, given that it is used within design limits of the software.

To achieve the above goals, various forms of stress testing are generally applied to a system to determine how a given system performs under load. This may include testing in which a system is subjected to unrealistically harsh inputs or load with inadequate resources with the general intention of breaking or faulting the system. For instance, this can include testing conducted to evaluate a system or component at or beyond the limits of its specified requirements. Generally, stress tests are designed to confront programs with abnormal situations. Thus, stress testing executes a system in a manner that may demand system resources in abnormal quantity, frequency, or volume.

One important component of system/component stress testing relates to load testing that attempts to stress systems by exercising components beyond that which is perceived or determined to be worst case operating conditions for the system. For instance, companies with mission critical web applications cannot afford to have poorly performing web sites as demand for the sites changes. As web site growth evolves, and systems are upgraded, the complexity of a company's web site architecture increases, for example. Thus, as components within the web architecture change, applications operating the sites are increasingly likely to encounter performance issues. Consequently, software applications can experience a great number of users with unpredictable load variations.

Some companies offer load testing applications to measure and predict the behavior and performance of an application on a global scale. This may include load testing both a determined infrastructure and architecture of an application by simulating a large number of users with many different profiles. Also, these applications can be combined with performance and transaction monitors in order to provide specific performance data for the different components of the application architecture. An output of these load and stress tests can be reports that identify in real-time any bottleneck and its cause that has been experienced by the system. One problem with conventional stress and load testing methodologies is that merely testing a system at its breaking point or overload condition may not be the most efficient way to determine reliability let alone determine whether or not the software under test will reliably operate as specified. Also, although conventional methodologies often focus on detecting the weakest link in a system, they often times obscure other problems which may in fact be more significant to a user/customer.

### SUMMARY OF THE INVENTION

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

The subject invention relates to systems and methods for automatically testing and stressing computer applications or components in accordance with a plurality of networked or localized computer system targets under test. One or more test profiles are provided that describe software actions (e.g., likely computer usage events) related to operations of the computing system, wherein the actions can be specified from data gathered from actual or modeled usage data, for example. A weighting component specifies likelihoods of the software actions in order to more closely test or simulate the operations of the computing system. By weighting the software actions according to the likelihoods, wherein one type of application task is determined or specified to be more likely than another type of task, the subject invention allows tests teams to uncover software problems that are more relevant to actual customer or usage situations. Thus, rather than merely running exaggerated load testing which may spend too much time on one test while forgoing broader system tests that more closely model an application's environment, the subject invention promotes discovery of problems in an efficient manner and is more likely to uncover or encounter real-world problems over conventional overload testing models.

Other aspects of the subject invention include providing a test selection module that determines which of various software tests are to be executed on the target systems. The software tests exercise the weighted software actions in order to predict future behavior of a given or simulated computing system. A test harness automatically implements and executes the software tests on a plurality of client and/or server configurations that represent a plurality of potential target systems or environments. As tests are run or completed, a database logs performance data from the software tests, wherein one or more reliability models can be applied to the performance data in order to predict and/or correct future computing system performance.

To the accomplishment of the foregoing and related ends, certain illustrative aspects of the invention are described herein in connection with the following description and the annexed drawings. These aspects are indicative of various ways in which the invention may be practiced, all of which are intended to be covered by the subject invention. Other advantages and novel features of the invention may become apparent from the following detailed description of the invention when considered in conjunction with the drawings.

### BRIEF DESCRIPTION OF THE DRAWINGS

FIG. 1 is a schematic block diagram illustrating a stress testing system in accordance with an aspect of the subject invention.

FIG. 2 is a schematic block diagram illustrating a test harness controller in accordance with an aspect of the subject invention.

FIG. 3 illustrates example profile configuration and weighting in accordance with an aspect of the subject invention.

FIG. 4 illustrates example system configuration aspects in accordance with an aspect of the subject invention.

FIG. 5 illustrates an example user interface in accordance with an aspect of the subject invention.

FIG. 6 is a flow diagram illustrating automated software testing in accordance with an aspect of the subject invention.

FIG. 7 is a schematic block diagram illustrating a suitable operating environment in accordance with an aspect of the subject invention.

FIG. 8 is a schematic block diagram of a sample-computing environment with which the subject invention can interact.

### DETAILED DESCRIPTION OF THE INVENTION

The subject invention relates to systems and methods for automatically testing computer components on a plurality of computer system targets. In one aspect, a system is provided to facilitate software testing of a computing environment. The system includes at least one profile to describe software actions that relate to operations of a computing system, wherein the actions can be specified from usage data gathered from customer marketing surveys or other sources, for example. A weighting component specifies likelihoods of the software actions in order to more closely test or simulate actual operations of the computing system, whereby a test selection module employs the likelihoods to determine software tests that exercise the software actions in order to predict future behavior of the computing system. A test harness (e.g., software component running on a control platform) executes the software tests on one or more target computing systems. During and after test execution, a database logs performance data from the software tests, wherein one or more reliability models can be applied to the performance data in order to determine and improve future computing system performance.

As used in this application, the terms “component,” “profile,” “system,” “harness,” “object,” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers. Also, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal).

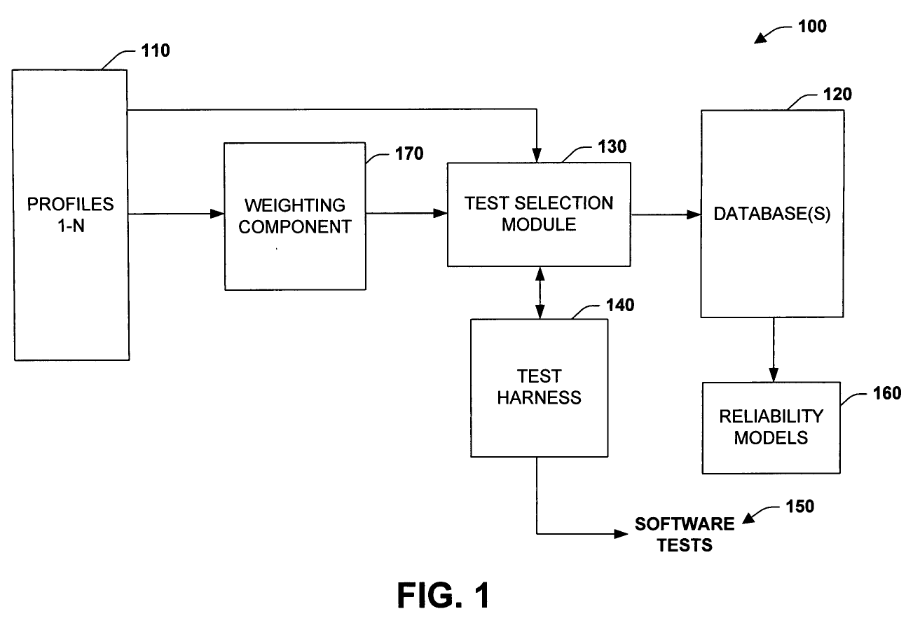

Referring initially to FIG. 1, a stress testing system 100 is illustrated in accordance with an aspect of the subject invention. The system 100 includes tools for finding and prioritizing software defects and assessing the quality of software products during the development cycle or during other phases such as product upgrades. The system 100 allows test teams to uncover bugs or other defects (e.g., product inconsistencies) more relevant to customers earlier by mirroring customer activity; it also enables software developers to measure and predict system reliability by applying mathematical models to a monitored or detected pattern of failures. Other features includes time savings by detecting costlier software defects, in the sense of defects that have a higher impact on system reliability, earlier and provides an early insight into the quality of software products under development.

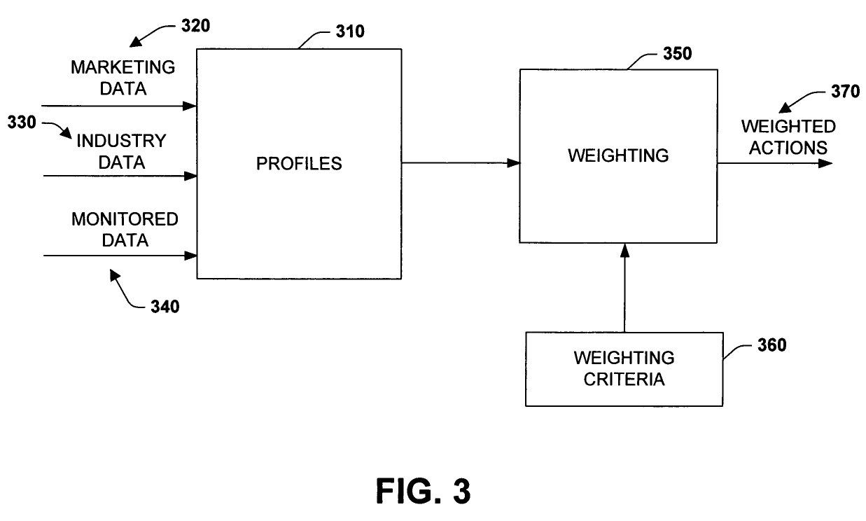

In one aspect, the system 100 includes one or more customer profiles 110. Generally, the profiles 110 include a list of repetitive actions a customer performs when using a respective software product. These actions can also be specified with a repetition rate describing how often a particular action occurs. The type of data represented in the profiles 110 is discussed in more detail below with respect to FIG. 3. Other components include a set of tests or components that implement or simulate the customer actions defined in the profiles 110. Such tests can be stored in a database 120 and queued for execution at random or predetermined times by a test selection module, wherein a test harness 140 (e.g., software component responsible for loading and executing tests on computers) performs test execution by loading respective software tests 150 on clients and/or server systems, for example. During and after test execution of the software tests 150, data can be gathered at the database 120 relating to the performance of the test, wherein one or more reliability models 160 can be employed to predict whether or not a tested system or component is satisfactory for release. Other components not shown include a reporting website of the performance data in the database 120 and or reliability estimates from the models 160.

Typically, the customer profiles 110 are first defined based on marketing data or other type information described below. Thus, regular client, server or computer operation can be broken down into simpler actions. For a given profile 110, a weighting component 170 defines or determines a relative weight that is calculated for each software action defined in the profile 110 based on its frequency and the frequency of other actions listed in the profile. Also, each of the customer actions defined in the profile 110 is generally implemented as a test 150. The test selection module 130 is a software program or component that repeatedly selects actions for a given profile 110 in a random manner but proportional with the relative weight of each action described in the profile. Depending on the specific action selected, the test selection module 130 also selects a client and/or a server to run the given action on. Then, the test selection module 130 instructs the test harness 140 to run the corresponding test for the respective action described in the profile 110.

After test execution, a positive or negative result is logged in the database 120. This result, along with other indicators that include event log errors, debugger breaks, and so forth can be used in determining when a failure occurs. Failures are generally logged along with the point in time when they occurred. Furthermore, failures can be diagnosed and addressed, whereby any detected pattern of failures can be employed with the reliability models 160 to predict future behavior of the system 100. It is noted that the profile 110 can describe software actions in substantially any computer language. For example, XML or other type data structures may be employed to describe the software actions specified in the profile.

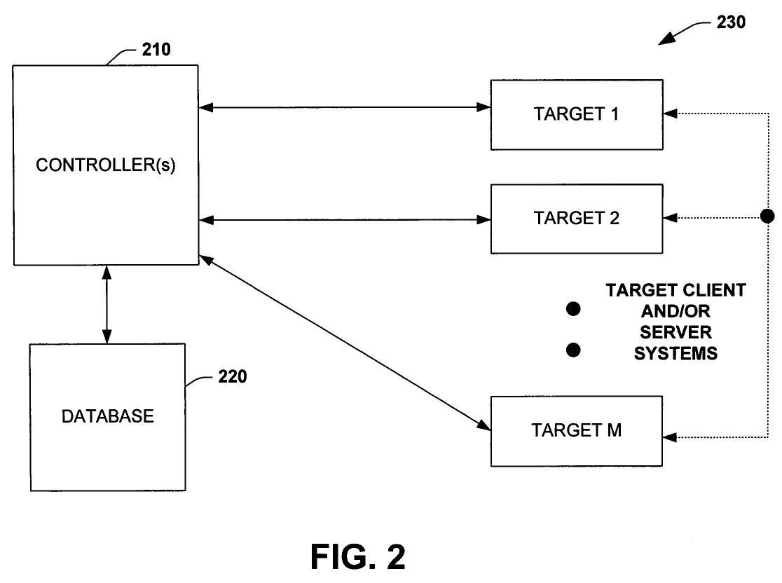

Referring now to FIG. 2, a system illustrates a test harness controller 210 in accordance with an aspect of the subject invention. The test harness controller 210 (also referred to as controller) runs a plurality of software tests that implement or mimic customer actions, wherein the respective tests are retrieved from a database 220. As noted above, the profiles generally describe actions that may be attempted whereby the tests are designed to correspond to or exercise the actions. The software tests stored in the database 220 are specified to the controller 210 via the test selection module described above. Such tests can also be associated with machine addresses or node identifiers which select one or more target systems 230 to run the respective tests. As can be appreciated, the target systems 230 can be configured for substantially any type of arrangement including server systems, client systems, stand alone systems, and/or combinations thereof. In general, the number of tests can be varied depending on the numbers of users which are expected to be serviced by a given system or as specified in the profiles. Typically, the controller 210 loads a test from the database 220 into one of the target systems 230 such as loading a target as a server system. The controller 210 then causes the test to be executed on the target 230 and monitors for results from the test. As can be appreciated many test can be run in parallel on the target systems. For instance, if a first target is set to run one or more server applications, the controller 210 can load one or more other targets with client applications or tests and proceed to execute those tests concurrently or sequentially with the server tests in the first target system 230.

FIG. 3 illustrates example profile configuration and weighting in accordance with an aspect of the subject invention. A profile component 310 is configured via various types of data that describes software actions of a system under test. These actions can be derived from likely usage scenarios of a computing system or component. They can describe operating environments, number of users, hardware configurations such as memory allocations, execution speeds for components, network configurations, driver configurations, registry configurations, files, database configurations, or other types of inputs to be tested such as keyboard inputs, mouse inputs, audio or video inputs, software inputs from other components, and so forth. Data in the profiles 310 can be gathered from a plurality of sources to determine the underlying software or user actions of a test. For example, the profile data can be gathered from marketing or survey data 320. This can include gathering written or website data from users regarding expected usage of a system. At 330, industry data can be gathered to supplement or build the profile 310. Such data 330 can include standards data, test data, or other type data that may be generally accepted as representing likely tests or situations for a given application, industry or environment.

At 340, monitored data gathered from one or more existing systems can be employed. For example, components can be installed on a plurality of differing systems and/or configurations, wherein data is gathered from the systems over time. The monitoring components monitor substantially all aspects of a computing system to determine the potential types of actions that may occur on the monitored systems. After monitoring, data can be collected at a centralized website or database from a plurality of network nodes, analyzed and filtered if necessary, and then utilized to build the profiles 310.

After the profile 310 has been constructed describing possible user or software actions and associated tests to exercise the actions, a weighting component 350 is employed to assign weights or probabilities to the respective actions defined in the profile. This can include employing one or more weighting criteria 360 to assign a given likelihood for a software action specified in the profile 310. For instance, weighting criteria 360 can be assigned based on the frequency or repetition rate of a software action, from mathematical or reliability models, from previously detected patterns of usage, or from empirical analysis of typical or worst case system usage. When the actions have been weighted at 370, the weighted actions are then executed (via test selection module and harness described above) as tests on various server and/or client systems according to the assigned weights. For example, a first action may be weighted as 0.50 and a second action is weighted as 0.05 whereby the first action would execute in general ten times more often than the second action. As noted above, the software actions specified in the profile are generally executed in a random manner yet controlled as to the time and amount of execution according to the assigned weights.

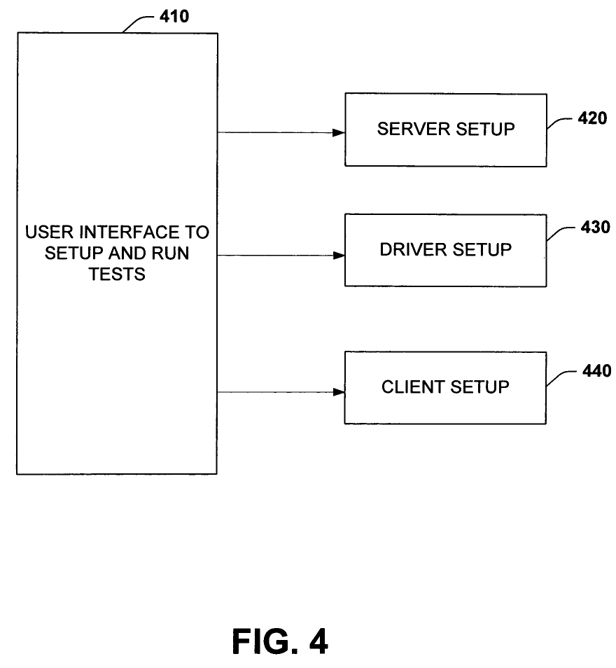

FIG. 4 illustrates example system configuration aspects in accordance with an aspect of the subject invention. In this aspect, a user interface 410 is employed to configure server components at 420, driver components at 430, and/or client components 440. The user interface can include such aspects as configurations wizards that lead customers in the installation and execution of the various software tests described above. The server or client components 420 or 430 can include such aspects as starting a server, configuring hardware, installing test modules to exercise software actions, and configuring related components such as printers, adding users, adding computers, connections to the Internet, configuring machines for remote access, configuring monitoring components for test performance, configuring back-up servers and clients, and so forth. Driver setup components 420 can include such aspects installing operating system components, installing test harness components, copying files, running a test setup component, configuring a data source administrator, and running a respective harness. Other aspects of the user interface 410 include creating user accounts, creating mailboxes for users, creating folders for users, adding users to security groups, adding users to distribution groups, configuring server access for users, setting up client computers for users, setting up network connections, setting up node and domain names, setting up connection types, configuring firewalls, setting up security configurations, setting up virtual private networks, configuring alert messages and times, along with other configurations.

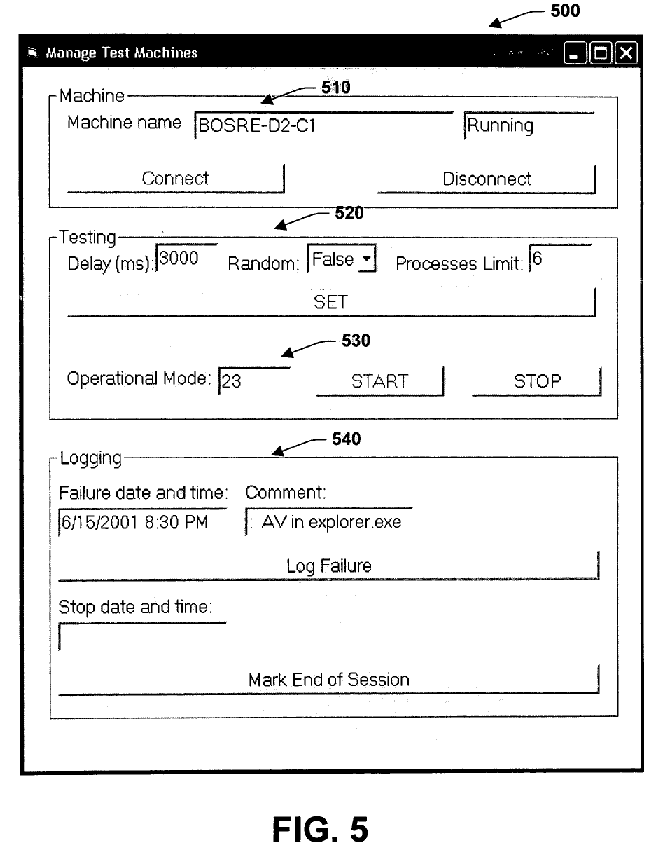

FIG. 5 illustrates an example user interface 500 for configuring or monitoring software tests in accordance with an aspect of the subject invention. As illustrated, the interface 500 includes a section 510 for defining a machine name to execute a respective test. Also, status can be provided regarding the particular state of a machine or test (e.g., running, stopped, and so forth). At 520, inputs are provided for defining test aspects such as delay times, random testing or predetermined intervals, and test process limits. At 530, operational modes can be displayed including selections for starting and stopping software tests. At 540, logging parameters for test data can be set-up including failure date and times, comments, a selection to log detected failures, and an input for defining a stop date and time for a given test.

It is noted that the user interfaces described above can be provided as a Graphical User Interface (GUI) or other type (e.g., audio or video file describing tests). For example, the interfaces can include one or more display objects (e.g., icon) that can include such aspects as configurable icons, buttons, sliders, input boxes, selection options, menus, tabs and so forth having multiple configurable dimensions, shapes, colors, text, data and sounds to facilitate operations with the systems described herein. In addition, user inputs can be provided that include a plurality of other inputs or controls for adjusting and configuring one or more aspects of the subject invention. This can include receiving user commands from a mouse, keyboard, speech input, web site, browser, remote web service and/or other device such as a microphone, camera or video input to affect or modify operations of the various components described herein.

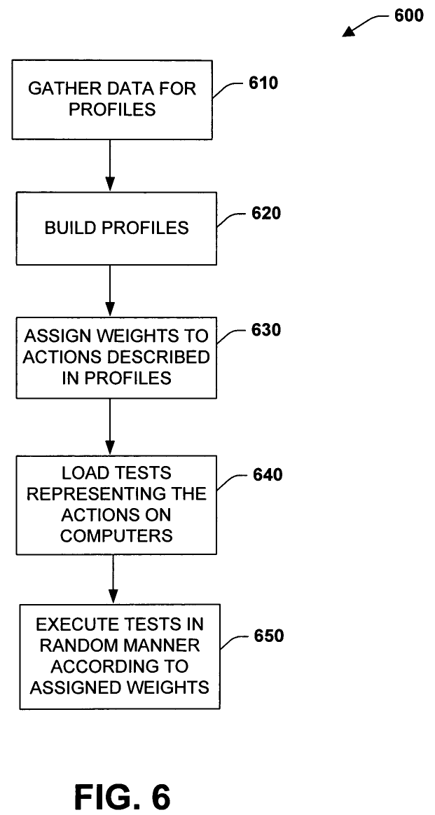

FIG. 6 illustrates an automated software testing process 600 in accordance with an aspect of the subject invention. While, for purposes of simplicity of explanation, the methodology is shown and described as a series or number of acts, it is to be understood and appreciated that the subject invention is not limited by the order of acts, as some acts may, in accordance with the subject invention, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the subject invention.

Proceeding to 610, data is gathered or defined to build a plurality of customer profiles describing modeled actions for a computer system under test. As noted above, the data for the profiles can be derived from various sources such as from marketing data, industry data, monitored data, modeled data, empirical data, and so forth. At 620, from the gathered data at 610, a plurality of profiles are constructed. This can include specifying various software actions for a modeled user or machine in the profile, wherein such actions can be specified in substantially any language such as Visual Basic, C++,

Pearl, Python, SQL, XML and so forth. At 630, weights are assigned to the various actions described in the profiles. For instance, the weights can be numerical information that describe how often a particular action should be run and in view of a representative load of users or machines that may be exercised in addition to the software actions defined in the profiles. At 640, a plurality of tests are loaded on various machines representing the weighted software actions described in the profiles. Such tests can be executed concurrently or sequentially on client, server or stand-alone systems in accordance with the number of profiles employed for a given round of testing. For instance, if 75 profiles are employed representing 75 users, wherein each profile defines a plurality of actions, 75 test blocks are executed on various machines in accordance with the plurality of actions within each block. At 650, the respective tests identified in the profiles are executed according to the assigned weights defined in the profiles. During or after test execution, performance and/or failure information can be gathered from the tests, wherein reliability estimates or models can be applied to the gathered data to predict future system reliability.

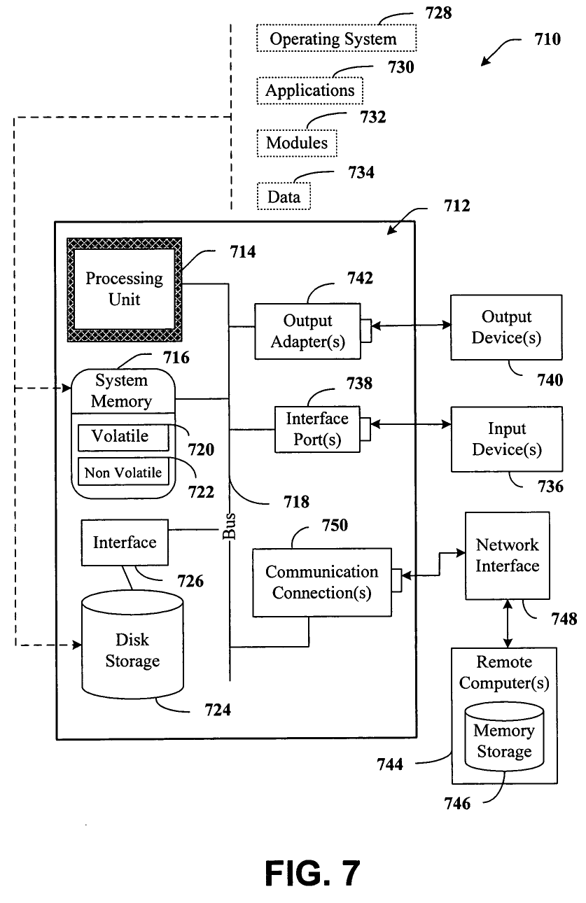

With reference to FIG. 7, an exemplary environment 710 for implementing various aspects of the invention includes a computer 712. The computer 712 includes a processing unit 714, a system memory 716, and a system bus 718. The system bus 718 couples system components including, but not limited to, the system memory 716 to the processing unit 714. The processing unit 714 can be any of various available processors. Dual microprocessors and other multiprocessor architectures also can be employed as the processing unit 714.

The system bus 718 can be any of several types of bus structure(s) including the memory bus or memory controller, a peripheral bus or external bus, and/or a local bus using any variety of available bus architectures including, but not limited to, 11-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 716 includes volatile memory 720 and nonvolatile memory 722. The basic input/output system (BIOS), containing the basic routines to transfer information between elements within the computer 712, such as during start-up, is stored in nonvolatile memory 722. By way of illustration, and not limitation, nonvolatile memory 722 can include read only memory (ROM), programmable ROM (PROM), electrically programmable ROM (EPROM), electrically erasable ROM (EEPROM), or flash memory. Volatile memory 720 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 712 also includes removable/non-removable, volatile/non-volatile computer storage media. FIG. 7 illustrates, for example a disk storage 724. Disk storage 724 includes, but is not limited to, devices like a magnetic disk drive, floppy disk drive, tape drive, Jaz drive, Zip drive, LS-100 drive, flash memory card, or memory stick. In addition, disk storage 724 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 724 to the system bus 718, a removable or non-removable interface is typically used such as interface 726.

It is to be appreciated that FIG. 7 describes software that acts as an intermediary between users and the basic computer resources described in suitable operating environment 710. Such software includes an operating system 728. Operating system 728, which can be stored on disk storage 724, acts to control and allocate resources of the computer system 712. System applications 730 take advantage of the management of resources by operating system 728 through program modules 732 and program data 734 stored either in system memory 716 or on disk storage 724. It is to be appreciated that the present invention can be implemented with various operating systems or combinations of operating systems.

A user enters commands or information into the computer 712 through input device(s) 736. Input devices 736 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 714 through the system bus 718 via interface port(s) 738. Interface port(s) 738 include, for example, a serial port, a parallel port, a game port, and a universal serial bus (USB). Output device(s) 740 use some of the same type of ports as input device(s) 736. Thus, for example, a USB port may be used to provide input to computer 712, and to output information from computer 712 to an output device 740. Output adapter 742 is provided to illustrate that there are some output devices 740 like monitors, speakers, and printers, among other output devices 740, that require special adapters. The output adapters 742 include, by way of illustration and not limitation, video and sound cards that provide a means of connection between the output device 740 and the system bus 718. It should be noted that other devices and/or systems of devices provide both input and output capabilities such as remote computer(s) 744.

Computer 712 can operate in a networked environment using logical connections to one or more remote computers, such as remote computer(s) 744. The remote computer(s) 744 can be a personal computer, a server, a router, a network PC, a workstation, a microprocessor based appliance, a peer device or other common network node and the like, and typically includes many or all of the elements described relative to computer 712. For purposes of brevity, only a memory storage device 746 is illustrated with remote computer(s) 744. Remote computer(s) 744 is logically connected to computer 712 through a network interface 748 and then physically connected via communication connection 750. Network interface 748 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 750 refers to the hardware/software employed to connect the network interface 748 to the bus 718. While communication connection 750 is shown for illustrative clarity inside computer 712, it can also be external to computer 712. The hardware/software necessary for connection to the network interface 748 includes, for exemplary purposes only, internal and external technologies such as, modems including regular telephone grade modems, cable modems and DSL modems, ISDN adapters, and Ethernet cards.

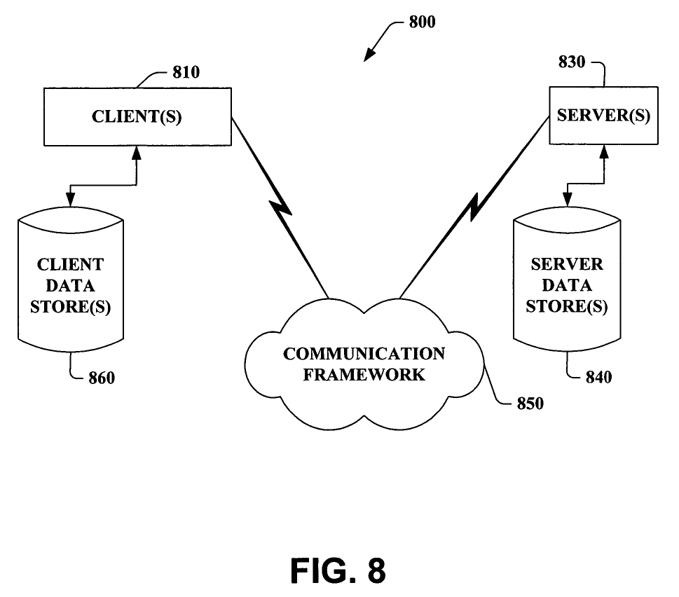

FIG. 8 is a schematic block diagram of a sample-computing environment 800 with which the present invention can interact. The system 800 includes one or more client(s) 810. The client(s) 810 can be hardware and/or software (e.g., threads, processes, computing devices). The system 800 also includes one or more server(s) 830. The server(s) 830 can also be hardware and/or software (e.g., threads, processes, computing devices). The servers 830 can house threads to perform transformations by employing the present invention, for example. One possible communication between a client 810 and a server 830 may be in the form of a data packet adapted to be transmitted between two or more computer processes. The system 800 includes a communication framework 850 that can be employed to facilitate communications between the client(s) 810 and the server(s) 830. The client(s) 810 are operably connected to one or more client data store(s) 860 that can be employed to store information local to the client(s) 810. Similarly, the server(s) 830 are operably connected to one or more server data store(s) 840 that can be employed to store information local to the servers 830.

What has been described above includes examples of the present invention. It is, of course, not possible to describe every conceivable combination of components or methodologies for purposes of describing the present invention, but one of ordinary skill in the art may recognize that many further combinations and permutations of the present invention are possible. Accordingly, the present invention is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system to facilitate software testing of a computing system, comprising:
at least one profile to describe software actions related to operations of a computing system; and
a weighting component to specify likelihoods of the software actions in order to test the operations of the computing system.

2. The system of claim 1, further comprising a test selection module that determines at least one software test that exercises the software actions in order to predict future behavior of the computing system.

3. The system of claim 2, further comprising a test harness to execute the software tests on one or more target systems.

4. The system of claim 2, further comprising a database to log performance data from the software tests.

5. The system of claim 4, further comprising one or more reliability models that are applied to the performance data in order to predict future computing system performance.

6. The system of claim 1, the profile includes a list of repetitive actions a customer or machine performs when a software product is executed.

7. The system of claim 6, the actions are specified with a repetition rate describing how often a particular action occurs.

8. The system of claim 2, the test selection module executes a set of tests or components that implement or simulate the software actions defined in the profiles.

9. The system of claim 8, the tests are queued for execution at random or predetermined times by the test selection module, wherein a test harness performs test execution by loading the tests on clients and/or server systems.

10. The system of claim 1, further comprising a reporting website to gather performance data from tests or determine reliability estimates from models.

11. The system of claim 1, the weighting component defines or determines a relative weight that is calculated for one or more software actions defined in the profile based on a frequency of the actions and a frequency of other actions listed in the profile.

12. The system of claim 1, further comprising a component to log positive or negative results, event log errors, and debugger breaks.

13. The system of claim 1, further comprising a controller that runs a plurality of software tests that implement or mimic customer or machine actions.

14. The system of claim 1, the profile is derived from marketing data, industry data, or monitored data.

15. The system of claim 1, the weighting component is associated with weighting criteria to assign a given likelihood for a software action specified in the profile, wherein the weighting criteria is derived from frequency or repetition rates of a software action, mathematical or reliability models, from previously detected patterns of usage, or from empirical analysis of typical or worst case system usage.

16. The system of claim 1, further comprising a user interface to setup a server system, a client system, or a driver.

17. The system of claim 16, the user interface includes components for starting a server, configuring hardware, installing test modules to exercise software actions, configuring including printers, adding users, adding computers, adding connections to the Internet, configuring machines for remote access, configuring monitoring components for test performance, or configuring back-up servers and clients.

18. The system of claim 16, the user interface includes components for installing operating system components, installing test harness components, copying files, running a test setup component, configuring a data source administrator, or running a test harness.

19. The system of claim 16, the user interface includes components for creating user accounts, creating mailboxes for users, creating folders for users, adding users to security groups, adding users to distribution groups, configuring server access for users, setting up client computers for users, setting up network connections, setting up node and domain names, setting up connection types, configuring firewalls, setting up security configurations, setting up virtual private networks, or configuring alert messages and times.

20. A computer readable medium having computer readable instructions stored thereon for implementing the components of claim 1.

21. A system for exercising a networked computer system, comprising:
means for gathering customer or machine software usage data;
means for assigning weights to the usage data;
means for selecting tests that simulate actions relating to the usage data; and
means for executing the tests.

22. The system of claim 21, further comprising means for applying reliability predictions to the usage data.

23. A method for automatically testing and exercising computer systems, comprising:
describing machine or customer actions in a user profile;
automatically assigning a frequency to the customer actions;
designing software tests for the customer actions;
loading the software tests on a client, a server, or a stand-alone machine; and
executing the software tests from a remote location in accordance with the frequency of the customer actions.

24. The method of claim 23, further comprising executing the software tests in a random or a pre-determined manner.

25. The method 23, further comprising executing the software tests in accordance with a test block, wherein the test block is associated with a single user profile.

26. The method of claim 23, further comprising automatically logging performance data for the performance tests and applying reliability models to the performance data to predict future system performance.

27. A system to exercise networked software components, comprising:
a plurality or user profiles modeling user or machine software actions;
a frequency component to define a rate for the software actions;
a test selection module to select tests that exercise the software actions;
a test harness controller to execute the tests on a plurality of computers in a random manner;
a website to log performance data from the tests; and
at least one reliability model to analyze the performance data.
